(19) United States
(12) Patent Application Publication
(10) Pub. No.: US 2008/0104552 A1
(43) Pub. Date: May 1, 2008

(54) Power consumption optimizing method for semiconductor integrated circuit and semiconductor designing apparatus

(76) Inventor: Jun Yamada, Kanagawa (JP)

Correspondence Address: MCDERMOTT WILL & EMERY LLP, 600 13TH STREET, NW, WASHINGTON, DC, 20005-3096, US

(21) Appl. No.: 11/976,789

(22) Filed: Oct. 29, 2007

(30) Foreign Application Priority Data
Oct. 31, 2006 (JP) 2006-295118

(51) Int. Cl. G06F 17/50

(52) U.S. Cl. 716/2

(57) ABSTRACT

Disclosed in a power consumption optimizing method for optimizing the power consumption in a semiconductor integrated circuit, which is employed in circuit designing in which the specification of the semiconductor integrated circuit is described in HDL and from the source described in said HDL, logic composition and layout design are performed. The power consumption optimizing method includes an activity information acquiring step of executing circuit simulation using said source to acquire activity information indicative of the activity of each logic path described in said HDL; and a logic composition step of executing said logic composition considering the power consumption of each logic path on the basis of said activity information.

### BACKGROUND OF THE INVENTION

1. Field of the Invention

This invention relates to a power consumption optimizing method for optimizing the power consumption in a semiconductor integrated circuit and a semiconductor designing apparatus.

2. Description of the Related Art

In designing a semiconductor integrated circuit, with a cell library being previously prepared in which a logic gate, a flip-flop, the circuit component in which they are combined, circuit components having different gate channel widths and threshold voltages are registered as standard cells, these cells are arranged/wired to realized a desired specification.

FIG. 4 is a flowchart showing a conventional designing procedure of the semiconductor integrated circuit. In the designing of the semiconductor device, first, the specification of the semiconductor integrated circuit is designed (step S101). After the specification is designed, the source in which the specification is described in HDL (Hardware Description Language) is created (step S102).

In order to realize the specification described in the HDL, a net list defining the connection relationship among the cells registered in the cell library prepared previously is created (step S103). The process from the HDL description to the net list creation is called logic composition. In this logic composition, referring to the timing information and logic information stored of each cell in the cell library, in order that the desired timing and function can be realized in the logic paths inclusive of the paths from an input terminal to flip-flops, paths among the flip-flops and paths from the flip-flops to an output terminal, the delay time of each logic path is computed.

It is determined whether or not the delay time computed of each logic path satisfies a predetermined standard (step S104). If the predetermined standard is not satisfied, the procedure returns to step S103 in which the circuits with the same specification are realized in various manners, for example, by changing the cell library to be used. Further, selection and connection of the cells are made so that the delay time of each logic path satisfies the predetermined standard.

On the basis of the net list created by executing the logic composition, the arrangement of the cells and wirings among the cells are performed (step S105). The step of executing the arrangement of the cells and wiring among the cells is called layout design. Further, it is determined whether or not the delay time after the layout design satisfies the predetermined standard (step D106). If the predetermined standard is not satisfied, the procedure returns to step S105 in which e.g. cell substitution is done so that the delay time satisfies the predetermined standard. The cell substitution is done in such a manner that the circuits with the same specification are realized in various manners referring to the layout information indicative of the positions of the input/output terminals of the cells for example by changing the cell library to be used if the predetermined standard is not satisfied.

If the delay time after the layout design satisfies the predetermined standard, GDS data for forming a photo-mask used in a manufacturing process of the semiconductor integrated circuit (step S107). Through the steps described above, the semiconductor integrated circuit is designed.

For the mobile device driven by a battery, power consumption is an important factor in determining the performance of the device. This also applies to the semiconductor integrated circuit incorporated in the mobile device. Further, since the semiconductor integrated circuit having a high clock frequency generates more heat during the operation, reducing power consumption is also important to reduce the quantity of generated heat.

Generally, the power consumption P in the semiconductor integrated circuit is expressed by the following Equation (1). Equation (1) has three parameters. All these parameters must be optimized.

P=P_{D}+P_{SC}+P_{LK} (1)

where P_{D} is power with a charged/discharged current component, P_{SC} is power of a passing-through current component and P_{LK} is power of a leak component. Further, P_{D} (power of a charged/discharged current component) and P_{SC} (power of a passing-through current component) are called dynamic power whereas P_{LK} (power of a leak component) is called static power.

Further, P_{D} (power of a charged/discharged current component), P_{SC} (power of a passing-through current component) and P_{LK} (power of a leak component) are expressed by the following Equations (2), (3) and (4), respectively.

P_{D}=P_{T}·C_{L}·V_{DD}²·F_{CK} (2)

P_{SC}=P_{T}·I_{SC}·T_{SC}·V_{DD}·F_{CK} (3)

P_{LK}=I_{LK}·V_{DD} (4)

where P_{T} is a switching rate, C_{L} is a load capacity, V_{DD} is a power source voltage, F_{CK} is a frequency, I_{SC} is a passing-through current, T_{SC} is the time of the passing-through current, and I_{LK} is a leak current.

In the case of P_{D} (power of a charged/discharged current), P_{T} (switching rate), V_{DD} (power source voltage) and F_{CK} (frequency) are determined by the system specification. Therefore, as long as the system specification is not changed, the percentage of C_{L} (load capacity) occupied in P_{D} (power of a charged/discharged current) is large.

In the case of P_{SC} (power of a passing-through current), P_{T} (switching rate), V_{DD} (power source voltage) and F_{CK} (frequency) are determined by the system specification. I_{SC} (passing-through current) is determined by the standard cell used. Therefore, the percentage of T_{SC} (time of the passing-through current) occupied in P_{SC} (power of a passing-through current) is large.

In the case of P_{LK} (power of a leak component), I_{LK} (leak current) is determined by the width of the gate channel of the standard cell used and the threshold voltage Vₜ. V_{DD} (power source voltage) is determined by the system specification.

In designing the semiconductor integrated circuit with low power consumption, the power consumption due to all the components indicated in Equation (1) should be minimized. However, in the arrangement composition and wiring processing in the logic composition step (step S103) and layout design step (step S105), except optimizing of the dynamic power at a portion normally operated such as a clock line, only optimizing of the static power was done. On the other hand, it is frequent that circuit simulation is done using the net list outputted in each step and others to confirm the power value of the dynamic power.

Further, in the Patent Reference 1, for each cell on the net list, the cell substitution is done on the basis of the information containing the width (size) of the gate channel and the threshold voltage Vₜ. In this method, the processing is done for only the net list in the logic composition step and afterward, thereby optimizing power consumption.

Patent Reference 1: JP-A-2003-308350

However, in the above power consumption optimizing method, in designing the semiconductor integrated circuit, as a result of optimizing the static power to the limit satisfying the restriction on the timing, as the case may be, even if the P_{LK} (power of a leak current) represented by Equation (4) was minimized, in the path with a high operating frequency, C_{L} (load capacity) that is one of parameters in Equation (2) and T_{SC} (time of a passing-through current) that is one of parameters of Equation (3) increased. At this time, the P_{D} (power of a charged/discharged current component) expressed by Equation (2) and P_{SC} (power of a passing-through current component) expressed by Equation (3), which are the dynamic power, increase so that the overall power consumption will increase.

Further, as described in Patent Reference 1, in the layout design, for the net list, where the information extraction, and optimization of power consumption in the processing step using this information are executed, the following problem occurred. Namely, if the information extraction from the net list with lower abstractness expressing the circuit and the above processing step are executed, the number of man-hours becomes enormous owing to the multi-function, large scale and complication of the semiconductor integrated circuits developed in recent years. So, the number of man-hours of the circuit simulation is not realistic.

### SUMMARY OF THE INVENTION

An object of this invention is to provide a power consumption optimizing method and a semiconductor designing apparatus which can optimize the power consumption of a semiconductor integrated circuit considering the power of a charged/discharged current component, power of a passing-through current component and power of a leak component without extremely increasing the number of man-hours.

This invention provides a power consumption optimizing method for optimizing the power consumption in a semiconductor integrated circuit, which is employed in circuit designing in which the specification of the semiconductor integrated circuit is described in HDL and from the source described in the HDL, logic composition and layout design are performed, comprising: an activity information acquiring step of executing circuit simulation using the source to acquire activity information indicative of the activity of each logic path described in the HDL; and a logic composition step of executing the logic composition considering the power consumption of each logic path on the basis of the activity information.

In the activity information acquiring step of the power consumption optimizing method, on the basis of a simulation result of the operation of the semiconductor integrated circuit or its partial operation, the activity of each logic path is computed.

In the logic composition step of the power consumption optimizing method, the activity information is added to each cell on a net list obtained in substitution of the cell for HDL description.

The power consumption optimizing method further comprises a weighting step of weighting the activity information added to each cell on the net list.

This invention provides a power consumption optimizing method for optimizing the power consumption in a semiconductor integrated circuit, which is employed in circuit designing in which the specification of the semiconductor integrated circuit is described in HDL and from the source described in the HDL, logic composition and layout design are performed, comprising: an activity information acquiring step of executing circuit simulation using a net list created by the logic composition to acquire activity information indicative of the activity of each cell on the net list; and a layout design step of performing the layout design considering the power consumption on the basis of the activity information.

In the activity information acquiring step of the power consumption optimizing method, on the basis of a simulation result of the operation of the semiconductor integrated circuit or its partial operation, the activity of each cell is computed.

The power consumption optimizing method further comprises a weighting step of weighting the activity information acquired in the activity information acquiring step.

This invention provides a semiconductor designing apparatus for optimizing the power consumption in a semiconductor integrated circuit, which is employed in circuit designing in which the specification of the semiconductor integrated circuit is described in HDL and from the source described in the HDL, logic composition and layout design are performed, comprising: an activity information acquiring means of executing circuit simulation using the source to acquire activity information indicative of the activity of each logic path described in the HDL; and a logic composition means of executing the logic composition considering the power consumption of each logic path on the basis of the activity information.

This invention provides a semiconductor designing apparatus for optimizing the power consumption in a semiconductor integrated circuit, which is employed in circuit designing in which the specification of the semiconductor integrated circuit is described in HDL and from the source described in the HDL, logic composition and layout design are performed, comprising: an activity information acquiring step of executing circuit simulation using a net list created by the logic composition to acquire activity information indicative of the activity of each cell on the net list; and

a layout design step of performing the layout design considering the power consumption on the basis of the activity information.

In accordance with the power consumption optimizing method for a semiconductor integrated circuit and a semiconductor designing apparatus according to this invention, the power consumption can be optimized considering all kinds of power inclusive of the power P_{D} of a charged/discharged current component, power P_{SC} of a passing-through current component and power P_{LK} of a leak component without extremely increasing the number of man-hours.

### BRIEF DESCRIPTION OF THE DRAWINGS

FIG. 1 is a block diagram showing a semiconductor designing apparatus according to the first embodiment.

FIG. 2 is a flowchart showing the designing procedure of the semiconductor integrated circuit in the first embodiment.

FIG. 3 is a flowchart showing the designing procedure of the semiconductor integrated circuit in the second embodiment.

FIG. 4 is a flowchart showing a conventional designing procedure of the semiconductor integrated circuit.

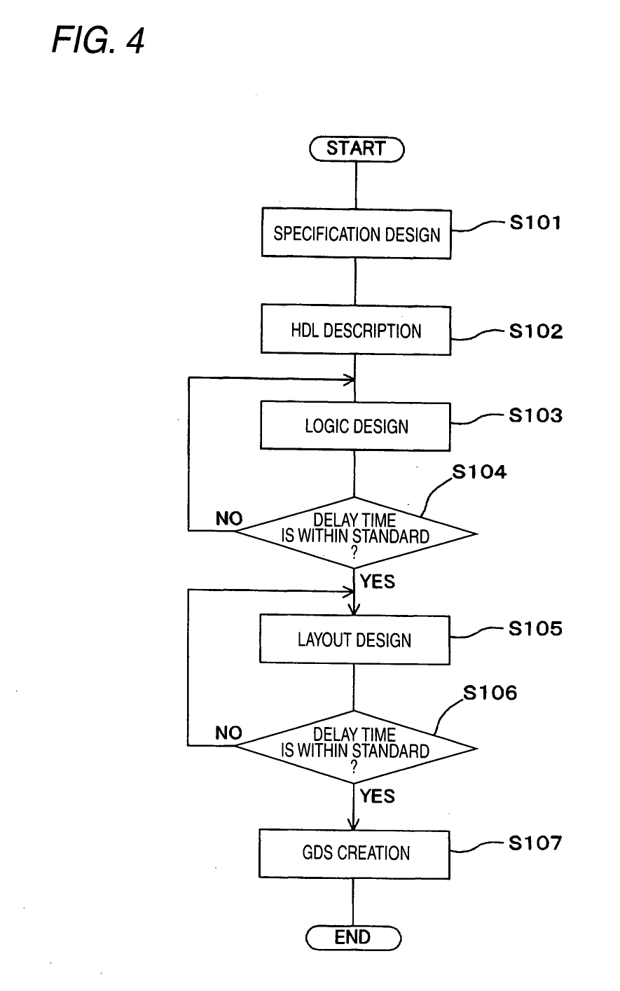

### DESCRIPTION OF THE PREFERRED EMBODIMENTS

Now referring to the drawings, an explanation will be given of embodiments of a power consumption optimizing method for a semiconductor integrated circuit and a semiconductor designing apparatus according to this invention. The power consumption optimizing method that will be explained below is applied to a semiconductor designing apparatus for designing a semiconductor integrated circuit. Further, the semiconductor integrated circuit is mounted in a mobile device driven by a battery and devices which must be operated at a high speed.

### Embodiment 1

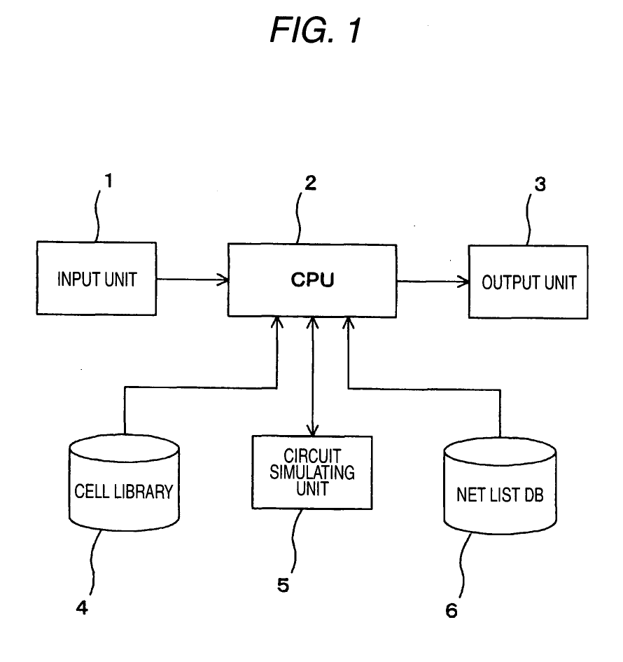

FIG. 1 is a block diagram showing a semiconductor designing apparatus according to the first embodiment. As seen from FIG. 1, the semiconductor designing apparatus includes an input unit 1, a CPU 2 and an output unit 3. The CPU 2 is connected to a cell library 4, a circuit simulation unit 5 and a net list DB 6.

The CPU 2 performs designing processing described later on the basis of the information such as the designing specification of the semiconductor integrated circuit inputted from the input unit 1. The output unit 3 outputs the processing result.

In the cell library 4, registered are a plurality of standard cells inclusive of a logic gate, a flip-flop, the circuit component in which they are combined and circuit components having different gate channel widths and threshold voltages of CMOS transistors. In accordance with an instruction from the CPU 2, the circuit simulating unit 5 performs the circuit simulation of an HDL description or the circuit simulation for the net list. In the net list DB 6, the net list outputted after the logic composition is registered.

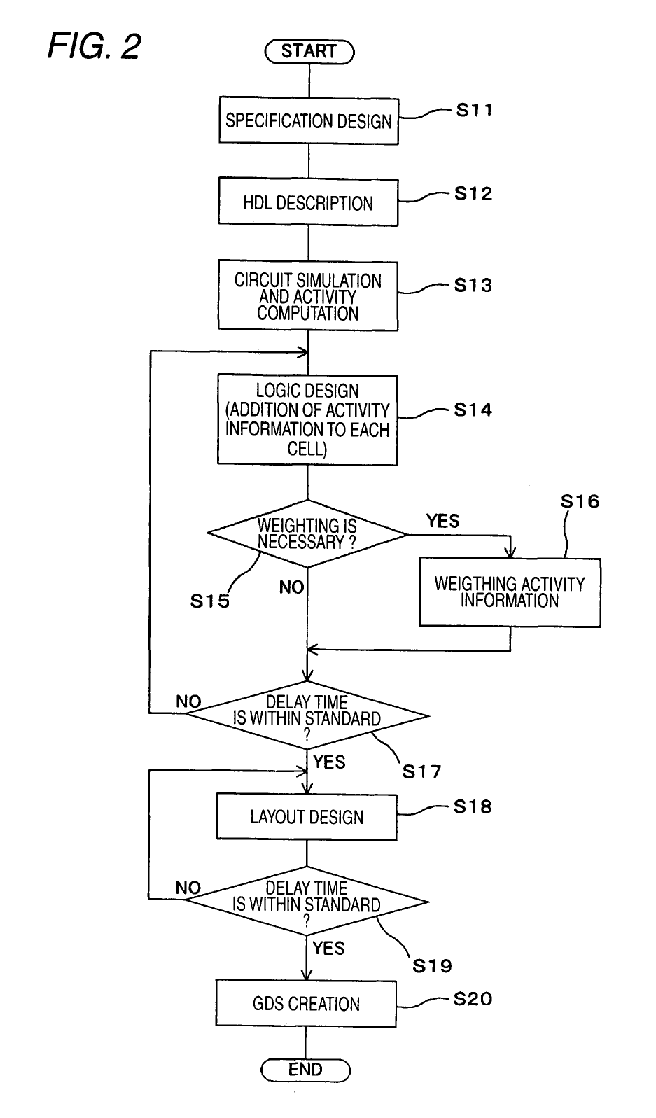

FIG. 2 is a flowchart showing the designing procedure of the semiconductor integrated circuit in the first embodiment. The processing in this procedure is performed in such a manner that the CPU 2 executes the program stored in the recording medium within the CPU 2. The CPU 2 designs the semiconductor integrated circuit according to the following procedure. First, the specification of the semiconductor integrated circuit is designed (step S11). After the specification is designed, the source in which the specification is described in HDL (Hardware Description Language) is created (step S12).

For this source, the circuit simulation of the same circuit operation as an actual circuit operation or its partial operation is executed to compute the activity (activity rate) of each of logic paths (step S13). This activity can be computed in the same algorithm as an automated tool for computing an inspecting coverage for the HDL description. This automated tool is generally employed to inspect the circuit configuration in the HDL description in developing the semiconductor integrated circuit.

Specifically, the automated tool for computing the inspecting coverage for the HDL description computes, through the circuit simulation, how many times the descriptions (logic paths) branched in, for example, the “case” description in Verilog-HDL language of the HDL language are activated, respectively. The logic path not activated even once means that it is not subjected to the operation simulation. By the same method, the activity for the HDL description is computed.

Next, the logic composition is executed (step S14). In this logic composition, for the source (step S12) in which the specification design of the semiconductor integrated circuit is described in the HDL, the translation information when the standard cells prepared in the logic composition substitute for the HDL description is outputted as intermediated information. This translation information can be outputted in the same algorithm as the translation information as the translation information by which the cells substitute for the HDL description, which is supplied into the automated tool for confirming the logic equivalence between before and after the standard cell substitutes for the HDL description. Namely, in the logic composition, the automated tool for confirming the logic equivalence between before and after the standard cells substitute for the HDL description, for example, where a multiplexer (selector type cell) with a selection signal substitutes for the “case” description in the Verilog-HDL language of the HDL language, this information or the other information suggesting this is outputted.

Using these items of information, at the places where the cells substitute for the HDL description, the activity information in the circuit simulation in the HDL description can be added. For example, where the “case” description in the Verilog-HDL language of the HDL language is activated 500 times per second in the circuit simulation so that the logic composition substitutes the selector cell for the “case” description, the activity information of being activated 500 times per second is added to the selector cell.

In the logic composition step (step S103) explained in the column of Background Art, since the wiring load capacity and others among the cells is not considered, the logic composition is executed without P_{D} (power of a charged/discharged current component) and P_{SC} (power of a passing-through current component) expressed in Equation (1) being considered. On the other hand, in this embodiment, the logic composition is executed using the activity information and translation information from the HDL description to the cells (step S14). Specifically, in the logic composition step in this embodiment, considering P_{D} (power of a charged/discharged current component) and P_{SC} (power of a passing-through current component), the timing information and logic information of each cell stored in the cell library 4 are referred to. In order that in the logic paths such as the paths from the input terminal to flip-flops, paths among the flip-flops and paths from the flip-flops to the output terminal, a desired timing and function are realized and also the delay time satisfies a predetermined standard, the selection and connection of the cells are executed. Further, to each cell on each path on the net list outputted after the logic composition, the activity information computed when the circuit simulation is executed is added.

Owing to the multi-function, large scale and complication of the semiconductor integrated circuits developed in recent years, as the case may be, it is difficult to execute the simulation in the same condition as the case where the semiconductor integrated circuit is used on the system. In this case, in this embodiment, using the result when the simulation is executed by the partial operation in the circuit, the activity information can be weighted. Specifically, it is determined whether or not the weighting is necessary for the activity information (step S15). If not necessary, the procedure, as it is, proceeds to the next step (step S17). On the other hand, if necessary, the activity information is weighted (step S16).

In the case where there is a circuit which executes one item of processing per ten seconds and the circuit simulation is done for its partial circuit, it is assumed that this partial circuit executes operation A twice and operation B three times and stops during the other operations. Considering the ratio of these operations occupied in the one item of processing per ten seconds, on the basis of the activity information in the circuit simulation in each of the operation A and operation B, the weight occupied in the one processing per ten seconds is added. Thus, even if the circuit simulation is not executed for ten seconds, the activity information equivalent to when the circuit simulation is executed can be added to the cells on the net list.

Further, the logic composition explained in the column of Background Art is generally executed under the condition in which the wiring load capacity is disregarded. In this embodiment, on the basis of the activity information acquired from the circuit simulation, for the cell with high activity, the cell capable of passing a large quantity of current by increasing the width of the gate channel of a CMOS transistor is preferentially allotted. The cell with a low threshold voltage Vt may be preferentially allotted.

After the logic composition is performed, it is determined whether or not the delay time satisfies a predetermined standard (step S17). If the predetermined standard is not satisfied, the procedure returns to step S14 and the logic composition is performed again.

After the delay time satisfies the predetermined standard, on the basis of the net list, the layout design in which P_{D} (power of a charged/discharged current component) and P_{SC} (power of a passing-through current component) are considered is performed (step S18). In performing the layout design (arrangement and wiring of the cells), using the restriction of the delay time and the activity information added to each cell in the logic composition step (step S14), the timing and power are optimized.

In the layout design in step S18, if the activity exhibited by the activity information added to each cell is high, on the basis of the load capacity C_{L} and the time T_{SC} of the passing-through current, in the substitution of the cell with a one rank larger width of the gate channel among prepared cells, a preferable cell is substituted in comparison of their decreased quantity in the power P_{D} of the charged/discharged current component and power P_{SC} of the passing-through current component and increased quantity of power P_{LK} of the leak component.

Inversely, if the activity exhibited by the activity information added to each cell is low, on the basis of the load capacity C_{L} and the time T_{SC} of the passing-through current, in the substitution of the cell with a one rank smaller width of the gate channel among prepared cells, a preferable cell is substituted in comparison of their increased quantity in the power P_{D} of the charged/discharged current component and power P_{SC} of the passing-through current component and decreased quantity of power P_{LK} of the leak component.

Upon completion of the above substitution processing for optimizing power consumption for all the cells to which the activity information is added, it is determined whether or not the delay time after the layout design satisfies the predetermined standard (step S19). If the predetermined standard is satisfied, the GDS data for making a photo-mask used in the manufacturing process of a semiconductor integrated circuit are created (step S20). Thereafter, the processing in this procedure is ended. On the other hand, if the predetermined standard is not satisfied, the procedure returns to step S18 and the layout design is performed again.

As described hitherto, in accordance with the power a power consumption optimizing method for optimizing the power consumption of a semiconductor integrated circuit and a semiconductor designing apparatus according to the first embodiment, without extremely increasing the number of man-hours, considering the power P_{D} of the charged/discharged current component, power P_{SC} of the passing-through current component and power P_{LK} of a leak component, the power consumption of the semiconductor integrated circuit can be optimized. Further, by executing the circuit simulation for the circuit described in the HDL, the time of the circuit simulation can be reduced. As the circuit scale is increased, the reduction effect is great so that the circuit simulation is useful for the large-scale semiconductor integrated circuits developed in recent years.

Further, by adding the activity information computed by the circuit simulation to the net list during the logic composition, the optimization of power consumption in performing the layout design can be facilitated. In executing the cell substitution, if the activity is high, by decreasing the load capacity C_{L} and shortening the time T_{SC} of the passing-through current so that the dynamic power is not increased, the static power (power P_{LK} of a leak component) can be increased and the dynamic power (power P_{D} of a charged/discharged current component and power P_{SC} of a passing-through current component) can be decreased. Further, where the number of man-hours in the circuit simulation is enormous, even if the circuit simulation of an actual operation is not executed, if the circuit simulation of its partial operation is executed, the activity information can be acquired. Further, this activity information can be employed for the logic composition and layout design.

### Embodiment 2

In the first embodiment, the circuit simulation was executed for the source described in HDL to compute the activity. In the second embodiment, the circuit simulation is executed for the net list subjected to the logic composition to compute the activity. The semiconductor designing apparatus according to the second embodiment, which is the same as in the first embodiment, will not be explained here.

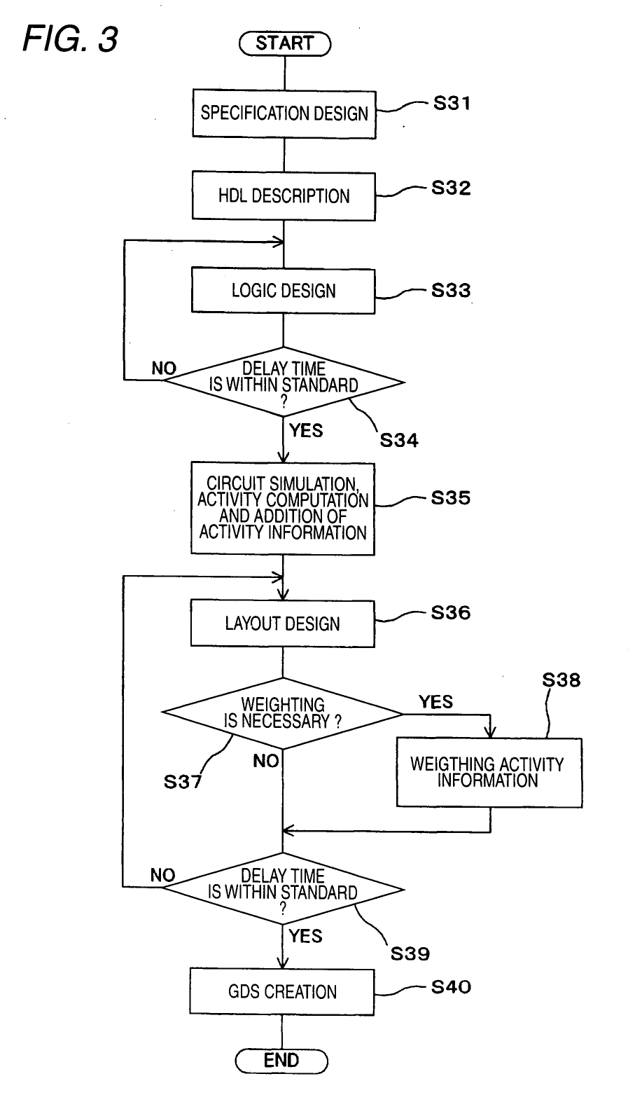

FIG. 3 is a flowchart showing the designing procedure of the semiconductor integrated circuit in the second embodiment. The processing in this procedure is performed in such a manner that the CPU 2 executes the program stored in the recording medium within the CPU 2. The CPU 2 designs the semiconductor integrated circuit according to the following procedure. First, the specification of the semiconductor integrated circuit is designed (step S31). After the specification is designed, the source in which the specification is described in HDL is created (step S32). For the source, the logic composition is performed (step S33).

In the logic composition step (step S33) performed in this embodiment, the wiring load capacity among cells and others are not taken in consideration. The logic composition, therefore, is performed without considering the power P_{D} of the charged/discharged current component and power P_{SC} of a passing-through current component. Thus, the power P_{LK} of the lead component is mainly optimized to create the net list. In this case, the power P_{D} of the charged/discharged current component and power P_{SC} of the passing-through current component are not considered and the timing information and logic information of each cell stored in the cell library 4 are referred to. Further, in order that in the logic paths such as the paths from the input terminal to flip-flops, paths among the flip-flops and paths from the flip-flops to the output terminal, a desired timing and function are realized and also the delay time satisfies a predetermined standard, the selection and connection of the cells are executed. Upon completion of the logic composition, it is determined whether or not the delay time satisfies the predetermined time (step S34). If the delay time does not satisfy the predetermined standard, the procedure returns to step S33 and the logic composition is performed again.

After the delay time satisfies the predetermined time, for the net list created in the logic composition step (step S33), the circuit simulation of the same operation as the actual circuit operation or its partial operation is executed to compute the activity for each cell on the net list and add it to each cell (step S35).

In performing the layout design (arrangement and wiring of the cells) on the basis of the net list, using the restriction of the delay time and the activity information added to each cell in the previous step (step S35), the timing and power are optimized (step S36).

In the case where the circuit simulation is executed for the net list, in comparison to the case where the same circuit simulation is executed for the HDL description, the abstractness in circuit expression is different so that the number of man-hours (time) of the simulation is increased. For this reason, where it is difficult to execute the simulation on the same condition as in the case where the semiconductor integrated circuit is employed on the system, using the result of the simulation executed in the partial operation of the circuit, the activity information is weighted. Specifically, it is determined whether or not weighting is necessary for the activity information (step S37). If not necessary, the procedure, as it is, proceeds to the next step (step S39). On the other hand, if necessary, the activity information is weighted (step S38).

In the layout design in step S36, like step S18 shown in FIG. 2 in the first embodiment, if the activity exhibited by the activity information added to each cell is high, on the basis of the load capacity C_{L} and the time T_{SC} of the passing-through current, in the substitution of the cell with a one rank larger width of the gate channel among prepared cells, a preferable cell is substituted in comparison of their decreased quantity in the power P_{D} of the charged/discharged current component and power P_{SC} of the passing-through current component and increased quantity of power P_{LK} of the leak component.

Inversely, if the activity exhibited by the activity information added to each cell is low, on the basis of the load capacity C_{L} and the time T_{SC} of the passing-through current, in the substitution of the cell with a one rank smaller width of the gate channel among prepared cells, a preferable cell is substituted in comparison of their increased quantity in the power P_{D} of the charged/discharged current component and power P_{SC} of the passing-through current component and decreased quantity of power P_{LK} of the leak component.

Upon completion of the above substitution processing for optimizing power consumption for all the cells to which the activity information is added, it is determined whether or not the delay time after the layout design satisfies the predetermined standard (step S39). If the predetermined standard is satisfied, the GDS data for making a photo-mask used in the manufacturing process of a semiconductor integrated circuit are created (step S40). Thereafter, the processing in this procedure is ended. On the other hand, if the predetermined standard is not satisfied, the procedure returns to step S36 and the layout design is performed again.

As described hitherto, in accordance with the power a power consumption optimizing method for optimizing the power consumption of a semiconductor integrated circuit and a semiconductor designing apparatus according to the first embodiment, even if the activity information of the cells is acquired after the circuit simulation is executed using the net list outputted by the logical composition, as in the first embodiment, considering the power P_{D} of the charged/discharged current component, power P_{SC} of the passing-through current component and power P_{LK} of the leak component, the power consumption of the semiconductor integrated circuit can be optimized.

The power consumption optimizing method for a semiconductor integrated circuit and a semiconductor designing apparatus according to this invention can optimize the power consumption in the semiconductor integrated circuit and are useful as the designing method and designing apparatus for of the semiconductor integrated circuit.

What is claimed is:

1. A power consumption optimizing method for optimizing the power consumption in a semiconductor integrated circuit, which is employed in circuit designing in which the specification of the semiconductor integrated circuit is described in HDL and from the source described in said HDL, logic composition and layout design are performed, comprising:
an activity information acquiring step of executing circuit simulation using said source to acquire activity information indicative of the activity of each logic path described in said HDL; and
a logic composition step of executing said logic composition considering the power consumption of each logic path on the basis of said activity information.

2. The power consumption optimizing method according to claim 1, wherein in said activity information acquiring step, on the basis of a simulation result of the operation of said semiconductor integrated circuit or its partial operation, the activity of each logic path is computed.

3. The power consumption optimizing method according to claim 1, wherein in the logic composition step, said activity information is added to each cell on a net list obtained in substitution of the cell for HDL description.

4. The power consumption optimizing method according to claim 2, further comprising a weighting step of weighting said activity information added to each cell on said net list.

5. A power consumption optimizing method for optimizing the power consumption in a semiconductor integrated circuit, which is employed in circuit designing in which the specification of the semiconductor integrated circuit is described in HDL and from the source described in said HDL, logic composition and layout design are performed, comprising:
an activity information acquiring step of executing circuit simulation using a net list created by said logic composition to acquire activity information indicative of the activity of each cell on said net list; and
a layout design step of performing said layout design considering said power consumption on the basis of said activity information.

6. The power consumption optimizing method according to claim 5, wherein in said activity information acquiring step, on the basis of a simulation result of the operation of said semiconductor integrated circuit or its partial operation, the activity of each cell is computed.

7. The power consumption optimizing method according to claim 6, further comprising a weighting step of weighting said activity information acquired in said activity information acquiring step.

8. A semiconductor designing apparatus for optimizing the power consumption in a semiconductor integrated circuit, which is employed in circuit designing in which the specification of the semiconductor integrated circuit is described in HDL and from the source described in said HDL, logic composition and layout design are performed, comprising:
an activity information acquiring means of executing circuit simulation using said source to acquire activity information indicative of the activity of each logic path described in said HDL; and
a logic composition means of executing said logic composition considering the power consumption of each logic path on the basis of said activity information.

9. A semiconductor designing apparatus for optimizing the power consumption in a semiconductor integrated circuit, which is employed in circuit designing in which the specification of the semiconductor integrated circuit is described in HDL and from the source described in said HDL, logic composition and layout design are performed, comprising:
an activity information acquiring step of executing circuit simulation using a net list created by said logic composition to acquire activity information indicative of the activity of each cell on said net list; and
a layout design step of performing said layout design considering said power consumption on the basis of said activity information.
